(19) United States
(12) Patent Application Publication
(10) Pub. No.: US 2017/0244687 A1
(43) Pub. Date: Aug. 24, 2017

(54) TECHNIQUES FOR CONFIDENTIAL DELIVERY OF RANDOM DATA OVER A NETWORK

(71) Applicant: Whitewood Encryption Systems, Inc., Boston, MA (US)

(72) Inventors: Richard MOULDS, Seekonk, MA (US); Richard John HUGHES, Los Alamos, NM (US); Jane Elizabeth NORDHOLT, Los Alamos, NM (US)

(21) Appl. No.: 15/442,243

(22) Filed: Feb. 24, 2017

Related U.S. Application Data
(60) Provisional application No. 62/299,273, filed on Feb. 24, 2016.

(51) Int. Cl. H04L 29/06; H04L 9/06

(52) U.S. Cl. CPC H04L 63/061; H04L 9/0631; H04L 63/0442; H04L 63/0435

(57) ABSTRACT

Techniques for confidential delivery of entropy and random data over a network are disclosed. In some embodiments, a client device may receive a first set of random numbers from a server and transform the first set using a second set of random numbers to generate a third set of random numbers. The client device may update a client secret key based on a first subset of the third set of random numbers and determine a re-key interval based on a second subset of the third set of random numbers. Also in some embodiments, the server may encrypt random numbers using a first key before sending to the client, and the client may decrypt the random numbers using a second, different and unrelated key to derive a different set of random numbers. By using mismatched keys, the client may preserve the confidentiality of the random numbers it ultimately uses.

### RELATED APPLICATION

This application claims the benefit of U.S. Provisional Patent Application Ser. No. 62/299,273, titled CONFIDENTIAL DELIVERY OF ENTROPY OVER A NETWORK, and filed on Feb. 24, 2016, which is incorporated by reference herein in its entirety for all purposes.

### FIELD OF DISCLOSURE

This disclosure generally relates to systems and methods for distributing entropy, and more particularly, techniques for securing the delivery of entropy over a network.

### BACKGROUND

Random numbers and other forms or random data are widely used by computer applications and are critically important to security applications that utilize cryptography. Random number generators (RNG) and pseudorandom number generators (PRNG), rely on sources of entropy in the form of random data to randomize their outputs. A wide variety of entropy sources are used in computer systems and sources of random data ranging from mouse movements, electrical noise and system timing jitter to quantum fluctuations.

### SUMMARY

In many situations, for example in virtualized systems, there can be insufficient levels of random data and it becomes beneficial to provide supplementary random data over a network. When delivering such random data from a server to a client system over a network, it is important that an eavesdropper not have the ability to gain any information about that random data. For example, if random data were used to create an encryption key at a client, an attacker who has prior knowledge of the random data could more easily conduct a brute-force attack to determine that key. Similarly, an attacker that is able to modify or replace the random data with a known value could influence the key generation process to make the keys easier to attack

Techniques for secure delivery of random data over a network are disclosed.

According to one aspect, the present disclosure is directed at a method for securely receiving encrypted random data at a client device from a server, the method comprising: receiving, at the client device, an encrypted set of random data from the server, wherein the encrypted set of random data is derived by encrypting an original set of random data using a server key; and transforming, at the client device, the encrypted set of random data by decrypting the encrypted set of random data using a client secret key that is unrelated to the server key to generate a third set of random data that is different from both the encrypted set of random data received by the client device and the original set of random data.

In some embodiments, the encrypted set of random data is derived by encrypting the original set of random data using the server key according to a symmetric key encryption-decryption algorithm; and the encrypted set of random data is transformed at the client device by decrypting the encrypted set of random data according to the same symmetric key encryption-decryption algorithm, using the client secret key that is different from the server key.

In some embodiments, the symmetric key encryption-decryption algorithm is an Advanced Encryption Standard (AES) algorithm.

In some embodiments, the encrypted set of random data is derived by encrypting the original set of random data using the server key according to an asymmetric key encryption-decryption algorithm; and the encrypted set of random data is transformed at the client device by decrypting the encrypted set of random data according to the same asymmetric key encryption-decryption algorithm, using the client secret key that is different from the server key, wherein the client secret key is not mathematically related to the server key according to requirements of the asymmetric key encryption-decryption algorithm.

In some embodiments, the encrypted set of random data is derived by encrypting the original set of random data using the server key according to a first encryption-decryption algorithm; and the encrypted set of random data is transformed at the client device by decrypting the encrypted set of random data according to a second encryption-decryption algorithm.

In some embodiments, the method can further comprise refreshing the client secret key at random intervals.

In some embodiments, the method can further comprise refreshing, at the client device, the client secret key at intervals that are unknown to the server, wherein the server is not informed when the client secret key is refreshed.

In some embodiments, the method can further comprise receiving, at the client device, another set of random data from the server; transforming, at the client device, the another set of random data using random data generated by a pseudorandom number generator local to the client device to derive a fourth set of random data; updating, at the client device, the client secret key based on a first subset of the fourth set of random data; determining, at the client device, a re-key interval based on a second subset of the fourth set of random data; determining, at the client device, when the re-key interval has elapsed; and when the re-key interval has elapsed, refreshing the client secret key.

In some embodiments, the method can further comprise receiving, at the client device, a secondary set of random data from a second server; and transforming the third set of random data using the secondary set of random data to generate a combined set of random data.

In some embodiments, the method can further comprise using the third set of random data as a seed for a pseudorandom number generator local to the client device, or to calculate a key for encrypting data for transmission or storage.

In another aspect, the present disclosure is directed at a client device configured to securely receive encrypted random numbers from a server, the client device comprising: at least one memory configured to store a client secret key; a communication interface configured to receive data from the server; and at least one processor coupled to the at least one memory and the communication interface, the at least one processor configured to: receive, via the communication interface, an encrypted set of random data from the server, wherein the encrypted set of random data is derived by encrypting an original set of random data using a server key, and transform the encrypted set of random data by decrypting the encrypted set of random data using a client secret key that is unrelated to the server key to generate a third set of random data that is different from both the encrypted set of random data received by the client device and the original set of random data.

In some embodiments, the at least one processor is further configured to refresh the client key at random intervals.

In some embodiments, the at least one processor is further configured to refresh the client secret key at intervals that are unknown to the server, wherein the server is not informed when the client secret key is refreshed.

In some embodiments, the at least one processor is further configured to: receive, at the client device, another set of random data from the server; transform, at the client device, the another set of random data using random data generated by a pseudorandom number generator local to the client device to derive a fourth set of random data; update, at the client device, the client secret key based on a first subset of the fourth set of random data; determine, at the client device, a re-key interval based on a second subset of the fourth set of random data; determine, at the client device, when the re-key interval has elapsed; and when the re-key interval has elapsed, refresh the client secret key.

In some embodiments, the at least one processor is further configured to: receive a secondary set of random data from a second server; and transform the third set of random data using the secondary set of random data to generate a combined set of random data.

In some embodiments, the at least one processor is further configured to use the third set of random data as a seed for a pseudorandom number generator local to the client device, or to calculate a key for encrypting data for transmission or storage.

In another aspect, the present disclosure is directed at a method for securely receiving random data at a client device from a server, the method comprising: receiving, at the client device, a first set of random data from the server; transforming, at the client device, the first set of random data using a client secret key to generate a second set of random data; determining, at the client device, a random re-key interval; determining, at the client device, when the re-key interval has elapsed; and when the re-key interval has elapsed, refreshing the client secret key at the client device.

In some embodiments, the random re-key interval is unknown to the server, and the client secret key is refreshed at the client device without informing the server.

In some embodiments, determining the random re-key interval comprises: transforming, at the client device, random data received from the server with other random data to generate a combined set of random data; and determining the re-key interval based on a first subset of the combined set of random data.

In some embodiments, the other random data is generated by a pseudorandom number generator local to the client device.

In some embodiments, refreshing the client secret key comprises: transforming, at the client device, random data received from the server with other random data to generate a combined set of random data; and refreshing the client secret key based on a second subset of the combined set of random data.

In some embodiments, the first set of random data is encrypted by the server, the method further comprising decrypting, at the client device, the first set of random data before transforming the first set of random data using the client secret key to generate the second set of random data.

In some embodiments, the first set of random numbers is encrypted and decrypted using keys established according to a Leighton-Micali protocol.

In some embodiments, data received by the client from the server is authenticated and verified according to a Leighton-Micali protocol.

In some embodiments, the method can further comprise using the second set of random data as a seed for a pseudorandom number generator local to the client device, or to calculate a key for encrypting data for transmission or storage.

In another aspect, the present disclosure is directed at a client device configured to securely receive random data from a server, the client device comprising: at least one memory configured to store a client secret key; a communication interface configured to receive random data from the server; and at least one processor coupled to the at least one memory and the communication interface, the at least one processor configured to: receive, via the communication interface, a first set of random data from the server; transform the first set of random data using a client secret key to generate a second set of random data; determine a random re-key interval; determine when the re-key interval has elapsed; and when the re-key interval has elapsed, refresh the client secret key.

In some embodiments, the random re-key interval is unknown to the server, and the at least one processor is configured to refresh the client secret key without informing the server.

In some embodiments, the at least one processor is configured to determine the random re-key interval by being configured to: transform random data received from the server with other random data to generate a combined set of random data; and determine the re-key interval based on a first subset of the combined set of random data.

In some embodiments, the other random data is generated by a pseudorandom number generator local to the client device.

In some embodiments, the at least one processor is configured to refresh the client secret key by being configured to: transform random data received from the server with other random data to generate a combined set of random data; and refresh the client secret key based on a second subset of the combined set of random data.

In some embodiments, the other random data is generated by a pseudorandom number generator local to the client device.

In some embodiments, the first set of random data is encrypted by the server, and wherein the at least one processor is further configured to decrypt the first set of random data before transforming the first set of random data using the client secret key to generate the second set of random data.

In some embodiments, the first set of random numbers is encrypted and decrypted using keys established according to a Leighton-Micali protocol.

In some embodiments, data received by the client from the server is authenticated and verified according to a Leighton-Micali protocol.

In some embodiments, the at least one processor is configured to use the second set of random data as a seed for a pseudorandom number generator local to the client device, or to calculate a key for encrypting data for transmission or storage.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 shows an exemplary system embodiment of the present disclosure.

FIG. 2 shows another exemplary system embodiment of the present disclosure.

FIG. 3 shows a call diagram of an implementation of an approach according to an embodiment of the disclosure.

FIG. 4 shows a rekeying process according to an embodiment of the present disclosure.

### DETAILED DESCRIPTION

Entropy can be delivered across an untrusted network in such a way that the client can trust both the source and integrity of the data, and that the data's contents are not known to an attacker. Standard secure communications protocols such as SSL/TLS can be used to provide data integrity, source validation, and confidentiality. However, these protocols may introduce a bootstrapping issue where the client must have enough random data with sufficient entropy to establish a trustworthy encryption key on startup in order to ensure secure communication with the server.

Moreover, since existing secure communications protocols are generally used to exchange human and machine readable messages and information contained in data files, they usually rely on a two-stage encryption and decryption processes. In these existing communications protocols, plain-text is encrypted at the sender to create cipher-text and cipher-text is decrypted at the receiver to recover the original plain-text. Encrypting/decrypting data in this manner requires that both sender and receiver (e.g., server and client) have access to an agreed-upon pair of cryptographic keys where such keys are identical (symmetric encryption) or mathematically related (asymmetric encryption). Establishing these keys at both sender and receiver may be performed by either pre-provisioning (e.g., sharing) encryption keys manually, delivering keys via some other encrypted channel, or by deriving keys through a mutual key agreement protocol. Manually pre-sharing encryption keys between server and client, however, is costly and inflexible unless keys are likely to remain unchanged for long periods of time and becomes cumbersome when larger populations of clients and/or servers need to communicate. Exchanging encrypted keys or deriving keys through an agreed-upon protocol (e.g., the SSL/TLS protocol) can mitigate these problems, and indeed, certain embodiments of the presently disclosed techniques can use such protocols. However, in some circumstances, these protocols can be complex to implement, may consume a significant quantity of CPU cycles at both server and client which can impose a performance burden, which can increase latency, and may lead to high system costs and/or capacity limits. Furthermore, many if not most existing key establishment schemes may be subject to future attack using quantum computers. These protocols also may rely on the availability of significant volumes of high entropy random data at both client and server prior to performing the message exchange. In such cases, it may be that only when both server and client have a copy of the required key or keys, irrespective of which key exchange method was employed, can messages and data be encrypted at the server and decrypted at the client.

Moreover, the server may become a point of vulnerability. Since the server encrypts data that the client can decrypt, it follows that the server contains information (e.g., keys and data) that is useful to an attacker who wishes to determine the data that is to be used by the client. Further, the server may retain a copy of the data that was transmitted to the client. Thus, if the server were compromised or is subject to legal inspection, this copy could be used to compromise the security of the client as well. This situation is even more concerning if the server and client are controlled by different entities—for example, in a cloud or hosted environment where messages or data are being provided as part of a service to tenants. Furthermore, since server and client have access to the same “clear text” data, there can be a trust issue with the operator of the server, especially when the number of clients is high compared to the number of servers.

In view of the foregoing, there may be significant benefits in adopting different security protocols and key management schemes that take advantage of the unique properties of random data when communicating that random data securely over a network, e.g., with confidentiality, data integrity and mutual authentication.

The approaches described herein may provide the secure transmission of random data across a network. The approaches described herein may ensure both the confidentiality and integrity of random data transmitted across the network, may reduce the overhead of a standard encryption scheme, may simplify the configuration and management of resilient, large-scale networks, may mitigate the bootstrapping issue discussed above and may prove to be resistant to attack with quantum computers.

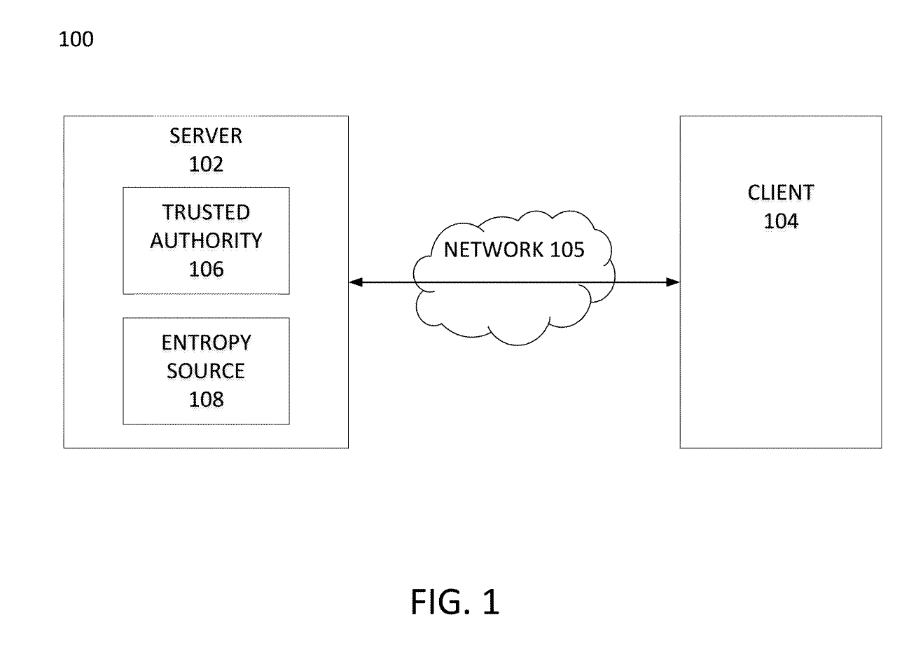

FIG. 1 shows an exemplary system embodiment of the present disclosure. As shown in FIG. 1, a system 100 includes a server 102 and a client 104. Server 102 communicates bi-directionally with a client 104 via a network 105, which according to various embodiments may include a local area network (LAN), wide area network (WAN), cellular or mobile network, a network internal to a single device or physical location, or the Internet. In some embodiments, the network 105 may be an unsecure network such that messages transmitted over it may be intercepted by one or more hostile eavesdroppers. Server 102 and/or client 104 may comprise, for example, one or more physical or virtual computing devices such as a desktop or laptop computer, a mobile computing device, a mobile phone, a tablet, a virtual machine executing on a distributed set of physical computing devices, a virtual container, a rack of servers, or the like, that requires the use of random data. Client 104 also may be a server itself. Both client 104 and server 102 may include one or more volatile and/or non-volatile memory devices (e.g., flash drives, optical drives, magnetic drives, RAM, cache, or other memory devices), a communication interface for communicating with each other via network 105 (e.g., a wired or wireless LAN, WAN, or cellular interface, a bus interface, and/or an optical interface), and one or more processing devices (e.g., microprocessors, processors, state machines, and/or application-specific integrated circuits). Both client 104 and server 102 may also include or be configured to include software or firmware stored as instructions on the one or more memory devices, and configured to be executed by the one or more processing devices to perform the functions described herein.

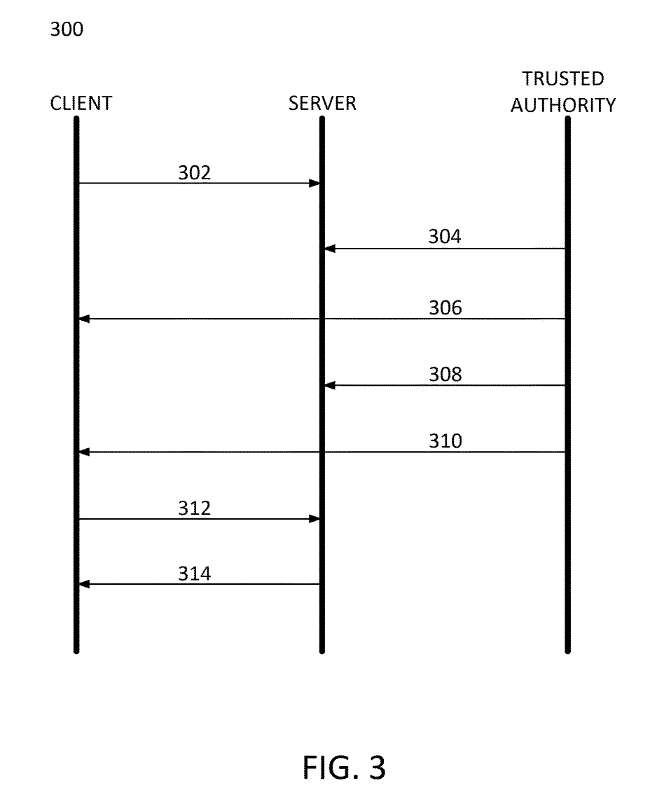

Server 102 may include entropy source 108. Entropy source 108 generates random data (entropy). Entropy source 108 may be a computing device communicably coupled, either directly or by way of one or more intervening components or interfaces, to the computing device that forms server 102, or may alternatively be part of the computing device that forms server 102. According to different embodiments, entropy source 108 may comprise a software-based pseudorandom number generator, or a device or software-based process that generates random numbers based on physical phenomena, such as mouse movements, electrical noise, system timing jitter, and/or quantum fluctuations. The random data generated by entropy source 108 may be a string, set, block, or the like of random numbers or bits. The random data may be generated by entropy source 108 for delivery to client 104 by server 102. Server 102 may also include a trusted authority (TA) 106. As discussed in further detail below in relation to FIG. 3, TA 106 may facilitate in establishing one or more secure communication channels between server 102 and client 104, in authenticating server 102 to client 104, and/or authenticating client 104 to server 102.

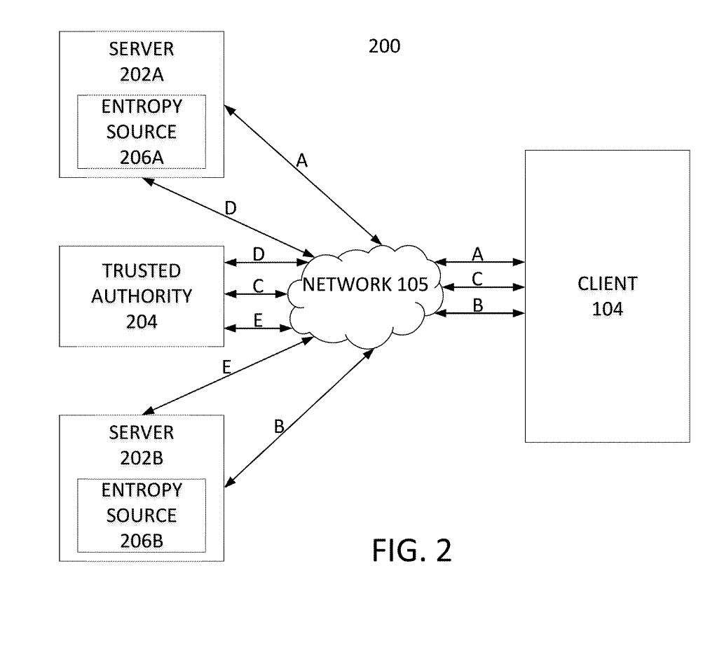

FIG. 2 shows another exemplary system embodiment of the present disclosure. As shown in FIG. 2, a system 200 includes a plurality of servers 202A and 202B, a trusted authority (TA) 204, and a client 104. The plurality of servers 202A and 202B may each comprise an entropy source 206A and 206B respectively—these entropy sources may be configured similarly to the entropy source 108 discussed above with regard to system 100. It should be noted that while only two servers 202 are shown in system 200, Z number servers 202 may be present in system 200, where Z is greater than or equal to two. Unless specifically indicated otherwise, further references to “servers 202” should be understood to refer to the plurality of servers present in system 200 rather than any individual server. Similarly, although only one client 104 is depicted in FIGS. 1 and 2, it should be noted that there may be multiple clients present. Servers 202 communicate bi-directionally with a client 104 via network 105. Network 105 may be as described above in regard to system 100. As shown by FIG. 2, a server 202A and client 104 may send and receive a communication A via network 105. Similarly, a server 202B and client 104 may send and receive a communication B via network 105. Servers 202 may comprise one or more physical or virtual computing devices, as discussed above with regard to server 102 in FIG. 1. Client 104 may be as described above in regard to system 100. As shown in system 200, client 104 can communicate with multiple servers 202. In the event that one of servers 202 has its security compromised or encounters system failure, client 104 can switch to communicate with a different server 202. Additionally, client 104 can have simultaneous relationships with multiple servers 202 and mix the random data it receives from each server to diversify risk of any single server being unavailable, faulty, or compromised.

Servers 202 may be isolated servers that do not communicate with each other. Having multiple, isolated servers 202 that need not share information between themselves can be beneficial because it eliminates the need for complex data sharing protocols and data security protocols that may be associated with dispersed (including geographically dispersed) servers. As will be described below, techniques for secure delivery of random data over a network according to the present disclosure may use public look up tables, and may not require the sharing of database information, such as user information and key information, between servers.

In contrast to server 102 described above in regard to system 100, servers 202 do not include a trusted authority (TA). As shown in system 200, trusted authority (TA) 204 is an external computing device that is separated from any of servers 202. As described in further detail below with regard to FIG. 3, TA 204 may facilitate in establishing one or more (e.g., encrypted and integrity validated) communication channels between one or more servers 202 and client 104, in authenticating one or more servers 202 to client 104, and/or in authenticating client 104 to one or more servers 202. Additionally, TA 204 may communicate bi-directionally with servers 202 as well as with client 104. As shown by FIG. 2, a TA 204 and server 202A may send and receive a communication D via network 105. Similarly, TA 204 and server 202B may send and receive a communication E via network 105. TA 204 and client 104 may send and receive a communication C via network 105.

System 200 provides risk mitigation because the client 104 is not limited to communicating with a specific server. In other words, system 200 allows client 104 to choose which individual server 202 to receive random data from, and/or to receive random data from multiple servers 202 simultaneously. This mitigates the risk associated with server hacking, server failure, and unauthorized eavesdropping of random data in server communication.

In communicating random data confidentially to client 104 from a server 102 as shown in FIG. 1 or from an individual server 202 as shown in FIG. 2, a number of approaches to the use of encryption may be employed. Other aspects of securing the exchange of random data such as authentication and data verification are described later.

### Confidentiality Approach 1—Traditional ‘End-to-End’ Encryption

As previously described, to avoid the threat of eavesdropping, random data may be encrypted by a server (such as server 102) prior to being transmitted over the network to a client (such as client 104), and decrypted upon receipt by the client. This approach may be used to share data in a confidential way because any successful eavesdropper would require the ability to decrypt the data. The encryption and decryption keys may be the same (symmetric encryption) or different but mathematically related (asymmetric encryption). Since the keys are either the same or closely related they can be pre-shared, for example by a manual process, they can be mutually agreed between client and server using a collaborative but secure process (key agreement) or they can be actively managed, facilitated or provisioned by a trusted entity, for example the TA.

### Confidentiality Approach 2—One Sided Encryption at the Client

The nature of random data makes it possible to define a light-weight, single-stage encryption approach that is specifically geared to delivering random data over a network in a secure way. Single stage approaches may provide transformation of random data at only the client. This contrasts with two-stage approaches, which provide encryption of random data at the server and decryption at the client.

Random data, unlike normal structured data, has the unique property that plain-text (unencrypted random data) and cipher-text (encrypted random data) are indistinguishable and have the same entropy, the measure of how random a dataset is. In the context of delivering random data over a network the plain-text and the cipher-text of the original random data are of equal value to the client.

According to the present disclosure, a single stage encryption approach for delivering random data over a network in a secure way is described. This single stage approach avoids the need to establish two-stage prior art encrypt/decrypt processes described in Approach 1, and therefore avoids the cost, complexity and security issues that may be associated with such prior art two-stage encrypt/decrypt processes.

Since the purpose of sending random data is to transfer entropy, the utility of random data is preserved even if it is passed though only a single transformation process and not a two-stage process. The single transformation process may take place at a receiving client, such as client 104. Since only the client transforms the random data it receives before using it, the server that transmitted the random data retains no information about the random data that was actually used by the client that would be useful to an attacker (or a malicious service provider, a competitor, etc.).

A wide variety of possible transformations may be used by the client, including, e.g., XORing or encrypting the received data with a client secret key to produce the transformed data. If the received data is encrypted, both symmetric and/or asymmetric encryption/decryption algorithms may be used, including an Advanced Encryption Standard (AES) algorithm, or a “quantum-safe” algorithm that is resistant to being cracked even by future quantum computers. The client secret key may be a key that is generated locally by a random number generator at the client device 104, or generated by some other means and, optionally, stored either temporarily or permanently in memory at the client device 104. The client can obtain and adopt the use of different secret keys at its own discretion. This flexibility results from the fact that the transformation process is only performed once and only at the client, so there is no requirement to store or archive previously used transformation values (for example, keys), or to share those values with any other party. Indeed, there is no need even to notify any other party of the transformation processes being applied. Thus, the client could change transformation process or transformation values as it pleases without notifying any other party, since it is the sole consumer of the transformed random data that it creates. Therefore, for the potential eavesdropper to gain any insight into the transformation process or values used by the client, the client itself would need to be compromised. If the attacker is able to gain this level of access to any given client, the security issue becomes moot since the attacker would have simpler methods to access sensitive data and/or modify other aspects of the client that do not require knowledge of the random data used by the client. Since each client can act independently to transform the random data it receives, an attack on one client yields no information that might enable an attacker to gain information about the random data used by other clients.

Benefits of the single stage client-side encryption approach include, but are not limited to, the following. With regard to confidentiality the client may operate in isolation and completely independently of the server and other clients (for example, there may be no need to share information about the transformation process externally), which may reduce the risk of a security breach due to a security breach of the other clients or the server. Moreover, the client can use one (or more) of a variety of random data transformation processes based on what is most convenient and/or secure, allowing the approach to be used on a wide variety of client types, including software and hardware based systems having various capabilities. Moreover the single stage encryption approach of the present disclosure provides that there is no need to store information about the transformation process on the client. The client can change the transformation process without constraint and without reference to processes used by other clients and/or servers and/or trusted authorities, and thus, the client can adapt over time, forcing a potential attacker to track or predict the changing transformation process or values/keys. However, in many practical cases the client will not act completely independently of the server. Often it will be the case that the client software is provided directly by the server to all clients. Therefore, not only will the server have knowledge of the transformation process but all clients will execute the same process and an eavesdropper merely has to be enrolled in the system as a legitimate client in order to determine the process. To overcome this concern the present disclosure includes the concept of ‘random rekeying’ whereby the client not only selects the transformation value or key on a random basis it can also base the rekeying interval, the length of time or number of operations that a particular key is used before it is changed for a different key, on the basis of a locally derived random value that is translated to represent a randomly selected time period or trigger point and therefore to determine randomly and independently when to change keys. Further, because the server and trusted authority need not perform a transformation process, there may be little performance burden placed on these devices.

However, there are some potential concerns about relying on this one-sided encryption approach at the client. Firstly, the approach exposes the plain-text random data to an eavesdropper. This raises concerns over perception and security. With regard to perception, there are long established standards, precedents and policies that require and expect to be verified that all sensitive data is encrypted before transmission over a network. Such standards, precedents and policies may regard random data sources used for critical or confidential applications as sensitive data. Secondly, the security model is based on the assumption that the entropy source of the server is of extremely high quality (i.e. is effectively perfectly random), for example as is typically the case with an entropy source based on quantum fluctuations or other quantum mechanical effects. If the random data is extremely random then an eavesdropper is incapable of distinguishing it from cipher-text. However, if the random data in not truly random and instead contains some level of bias (a non-equal probability of ones and zeros), correlation or patterns or worse still has failed completely and become all ones or all zeros and eavesdropper may be able to identify that stream as something other than cipher-text and infer information about the identity or operation of the server, and therefore the transformation process used by the clients and potentially the transformed random numbers created at the client.

### Confidentiality Approach 3—End-to-End Server Encryption and Client Decryption Followed by Additional Encrypt by the Client

To overcome the potential concerns raised over the use of one-sided client-side encryption i.e. that is may expose information regarding the entropy source and the random data generated at the server to an eavesdropper Approach 3, which is a combination of Approaches 1 and 2 can be used. Random data may be encrypted by a server (such as server 102) prior to being transmitted over the network to a client (such as client 104), decrypted upon receipt by the client (as described in the traditional case of Approach1) and then further transformed by the client as described above in the single transformation process of Approach 2. Approach 3 adds a further layer of security because the end-to-end confidentiality described in Approach 1 prevents the eavesdropper gaining any useful information about the entropy source and the process of generating random data at the server, whereas the client side transformation with random rekeying described in Approach 2 protects against session recording at the server and emulation of the transformation process by an attacker gaining information regarding the transformation process from other clients. Both end-to-end encryption and decryption information of the server and/or client, as well as information about the additional transformation process performed by the client must be determined by would-be attackers in order to gain information about the random numbers ultimately used by the client. However, this increased level of security comes at the cost of performing both a data decryption and data transformation process, which may be an additional encryption process, at the client, thus potentially incurring a performance degradation and requiring added complexity in terms of implementation and key management.

Confidentiality Approach 4—Single Encryption at the Server and Single Decryption at the Client with Mis-matched Keys

Approach 4 achieves the strength of the hybrid approach described in Approach 3 in a simplified construction. In approach 4, the server encrypts random data. The server may encrypt the random data in whichever way it pleases. For example, the server may encrypt the data using an encryption-decryption algorithm using a key known only to itself. The encrypted random data can then be transmitted confidentially to the client. The client now may decrypt the encrypted random data. The client may, in some embodiments, decrypt the encrypted random data according to the same encryption-decryption algorithm used by the server. However, the client need not use a decryption key that corresponds with the encryption key used by the server to encrypt the random data. If a symmetric encryption-decryption algorithm is used, for instance, the client need not use a decryption key that is the same as the encryption key used by the server. If an asymmetric encryption-decryption algorithm is used, the client need not use a decryption key that is mathematically related to the encryption key used by the server. As discussed above, asymmetric encryption-decryption algorithms are generally designed to encrypt data using a first key, and decrypt the data (i.e., recover the data before it was encrypted) using a second, different key that is mathematically related to the first key in some way. In certain embodiments of the disclosed techniques however, the second key that is used at the client need not be mathematically related to the encrypt key used by the server. This could mean, for instance, that the client secret key does not satisfy the mathematical relationship to the server key required by a particular asymmetric encryption-decryption algorithm in order to recover the original data before it was encrypted. Decrypting the data received from the server using a different decryption key leads to decrypted data that is different from the original set of random data that existed prior to encryption by the server. While this may be a serious problem when communicating messages and meaningful data, this is not an issue when distributing random data. Since the random data is random and is assumed to contain no intelligent information, the random data ultimately used by the client need not be the same as that originally provided and encrypted by the server, as long as the entropy of the originally generated random data is preserved in both the encryption by the server and decryption by the client. Thus, the server and client may use mis-matched keys in the encryption and decryption processes they perform. The use of mismatched keys at the client effectively replicates and replaces the single client-side transformation process described in approach 2, therefore reducing the number of decryption/transformation processes that must be performed at the client back to one. In some implementations the client and server may even implement different encryption and decryption algorithms. Irrespective of the algorithm used, both client and server can adopt the random rekeying process described in Approach 2 since no co-ordination of key values or rekeying activity is required between the client and server. Therefore, in this approach there are effectively three different values of random data in use for each transmission from server to client: the first block of random data generated by the server based on its local entropy source, the second block of random data created at the server after the encryption process using a key known only to the server and transmitted over the network, and a third block of random data created at the client using the decryption process and a key known only to the client. It is important to note that the value of the first block of random data is not equal to the value of the third block of random data. However, it should also be noted that if the server-side encryption key is shared with the client then the client and server can communicate in a hybrid way. Intelligent or meaningful data can be confidentially sent from the server to the client and decrypted using the server key (or an asymmetric key that is mathematically related to it) back to original plain-text; or instead, random data can be transmitted confidentially and the client can take steps to insulate itself from server-side session recording by decrypting using a key known only to the client, which itself can be rekeyed on a random basis.

Approaches 1, 3, and 4 differ from approach 2 in that the random data originally generated (e.g., by entropy source 108 or 206) at the server is encrypted before transmission to the client. In contrast, in Approach 2, the random data is sent in “plain-text”, meaning as generated, to the client. In comparison with Approach 2, Approaches 1, 3, and 4 have an advantage: an eavesdropper is prevented from acquiring knowledge about the server's random number source (e.g., entropy source 108 or 206). This can be an issue if the entropy source used by the server is not truly random, but produces data that is less than perfectly random that may exhibit known or discernable fingerprints or characteristics—such characteristics may be observed and exploited by eavesdroppers to gain information about the server's random number source, to gain information about the identity of the server, to make predictions about future random numbers generated by the server, or other information about the server that may ultimately weaken the security of the client or clients. By encrypting the random numbers generated by entropy sources 108 or 206 before transmission, the server mitigates the risk of eavesdroppers gaining such information.

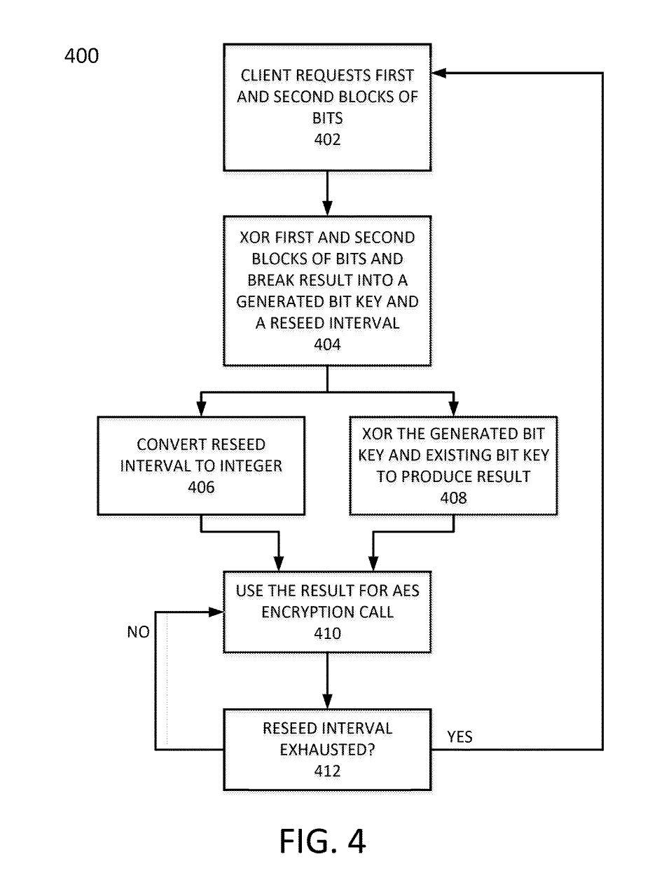

Approach 4 provides the optimum set of security properties with the minimum computational and key management impact at the client. It ensures that eavesdroppers never see the data that the client uses as random data because the client decrypts received random data using its own key that is known only to the client and never shared or replicated by the server. The client can pick its own keys to decrypt which means that the server doesn't know what random data the client ever used. This protects against session recording and data tracking at the server or by an eavesdropper that might provide useful information about the random data sent to and used by the client. Furthermore, the client can use a process of random rekeying such that a server, eavesdropper or any other client cannot predict even the rekeying interval, let alone the keys provided to the rekeying process and that are used to decrypt received encrypted random data. This process of random rekeying is described in further detail below in relation to FIG. 4.

Approach 4 can also provide a client with autonomy. Clients (such as client 104) can pick which server it receives random data from, potentially based on a public directory (as described below), and can communicate with multiple servers and combine the data as it wishes. Clients can keep private the decision about which servers that it selects to use. As discussed, clients can modify, using client side decryption, the received data using any key of their choice without having to share that decision or key with any server. A client can re-key as and when it likes (e.g., random rekey) and keep that strategy secret from any server. It should also be noted that if the client wishes to decrypt data from the server using a decryption key corresponding to the encryption key used by the server, for example to receive intelligent or meaningful messages that it wishes to restore to plain-text, the client can still be configured to have this capability, selecting either the server related decryption key, as established with the server or the private client transformation key as required.

### Rekeying

Approaches 2, 3 and 4 all enable the adoption of the ‘random rekeying’ concept which is now described in more detail. In some embodiments, the client may utilize a random rekeying strategy for determining the client secret key it will use to transform random data received from the server and to dynamically and unpredictably vary the frequency at which this client secret key is refreshed over time. For example, when generating the initial client secret key for the client side transformation (e.g., using an AES encryption algorithm), the client may request a certain number of bits (e.g., 256 bits) from a pseudorandom data source local to the client (e.g., from/dev/urandom on a Linux-based system), plus an additional number of bits (e.g., 8 bits) to be used as a random rekey interval. The first set of bits (e.g., 256 bits) can used as the initial client secret key, and the additional set of bits (e.g., 8 bits) can be converted to an integer N. This integer N may then be used to indicate the next reseed interval. After N packets of data have been received from the server the client secret key can be re-keyed using the method described below and shown in rekeying process 400 of FIG. 4, according to an embodiment of the present disclosure. A similar but alternative process could be implemented where the random value N relates to elapsed time (or some other value) rather than cumulative arrival of data packets.

According to rekeying process 400, upon re-key in step 402, a client such as client 104, for example, requests a first block of bits from a local entropy buffer. The local entropy buffer may be a local pseudorandom data source, such as a/dev/urandom Linux-based pseudorandom data source. The client also requests a second block of bits from a network entropy buffer. The network entropy buffer may be a server 102 or 202 that includes an entropy source 108 or 206. The first and second blocks of bits may be 264 bits in length, or may also be some other size. In situations where there is concern over lack of local entropy, for example at system startup it would be possible to pre-deliver a block of random data from an external source, including potentially the server, and to use this as a bootstrap random data source. This bootstrap source could also be updated and refreshed over time as new local entropy is captured or as network provided random data is received.

In step 404, the first and second blocks of random data are XOR'd together, or combined in some other way, and the result is broken into a generated transformation key and a reseed interval. For example, a 264 bit string derived from XOR'ing the first and second blocks of bits may be broken into a 256 bit key and an 8 bit string that represents an 8 bit reseed interval.

In step 406, the reseed interval is converted to an integer and serves as the new reseed interval for the current client secret key. In step 408, the newly generated key is XOR'd with the existing client secret key. In step 410, the result of the XOR in step 408 is used as an updated client secret key for subsequent client-side transformations (using, for example, an AES encryption algorithm). In step 408, the new key could also simply be used to replace the old key or be combined with the old key in some other way. In step 412, each time the client determines it is time to use the client secret key to transform random data received from the server, the client determines whether the reseed interval has been exhausted in step 412. The reseed interval may either represent a number of times that the client secret key may be used before it needs to be refreshed, an amount of time that the client secret key may be used for (irrespective of how many times it is used during that amount of time). If the reseed interval has not been exhausted, the current client secret key continues to be used. If the reseed interval has been exhausted, the process begins again at step 402.

Despite deriving an initial key from a local entropy buffer, which may be a /dev/urandom system buffer, and may be a low entropy system, the continuous rekeying from both local and network sources in process 400 quickly introduces additional entropy into the client secret key. This greatly increases its prediction resistance and mitigates the bootstrapping issues described above. The use of a random rekey interval as opposed to a static one also increases the prediction resistance of the client secret key by introducing another source of unpredictability into the system.

In addition to confidentiality, it is important have to consider other security matters associated with the distribution of random data, such as the need to establish mutual authentication and validation of data integrity. One of the objectives of the disclosed system is to establish a lightweight capability that imposes minimal load on both client and server, particularly since the client systems might be very low power and resource constrained devices, sometimes referred to as ‘internet of things’ (IoT) devices. Finally, an additional goal is to adopt security algorithms that might be considered safe against future attack by quantum computer.

FIG. 3 shows a call diagram 300 of an exemplary implementation of Approach 1 (traditional end-to-end encryption) according to an embodiment of the disclosure. The protocol depicted in call diagram 300 is an adaptation of T. Leighton and S. Micali's protocol, which was originally designed to facilitate transfer of secret, non-random messages, to instead facilitate distribution of random numbers. A description of Leighton and Micali's original protocol may be found at T. Leighton and S. Micali, “Secret-Key Agreement without Public-Key Cryptography”, Left. Notes. Comp. Sci. 773, 456 (1994), and at U.S. Pat. No. 5,519,778, granted May 21, 1996 (both of which are incorporated by reference herein). Diagram 300 may be easily adjusted to show an implementation of Approach 4 if mismatched, distinct keys are used by the client and server and as stated previously the client could effectively switch between Approach 1 and 4 depending on the nature or data being transmitted since under this embodiment of the protocol the correct server decryption key remains available to the client should it choose to use it. In addition, diagram 300 may be augmented to show an implementation of approach 3 if an additional transform step local to the client is performed at the end of the protocol, as described above. In embodiments of the presently disclosed system that use this protocol, the client is provided with assurance that the received random data comes from a trusted server and has not been modified by a third party—this may be the case regardless of the specific encryption approach/algorithm used. The client may also request random data from a plurality of servers and may therefore combine the random data it receives in a way that only the client knows.

Assurances regarding authenticity and integrity of random data and other messages can, in some embodiments, be provided by including an HMAC (Hash-based Message Authentication Code) that is calculated for every message sent by both the client (such as client 104) and server (such as server 102).

According to some embodiments, both the client and the server calculate an HMAC on each message they send to allow the receiver to verify the origin of the message and the integrity of the data. This HMAC can prevent an attacker from masquerading as the server and sending less than random data to the clients or from modifying the random data that is being sent to the clients. This HMAC can be calculated using a pre-shared authentication key that is generated at the server during client enrollment with the server, and can be transmitted to the client by a system administrator of the server. Because this authentication key can be generated on the server, the integrity of the authentication key can be assured since the server has a physical random number generator or other source of entropy (such as entropy source 108) providing it with random data. The HMAC key can then be moved onto the client by a system administrator, and can be protected at the client in the fashion deemed suitable by the organization's security policy. For example, the key could be protected in hardware protected and tamper-resistant memory such as that provided by Trusted Platform Module (TPM) chips, smart cards, secure USB memory devices or hardware security modules (HSM).

For the exemplary implementation depicted in call diagram 300 and described in the below description, the protocol used to transmit and secure random data from a server (such as server 102) to a client (such as client 104) can be represented as follows. H is a cryptographic hash function, such as a member of a SHA family, and may be SHA256. E is a symmetric key encryption algorithm, such as AES, used with, for example, a 256-bit key. For a bit string of random data plain-text X, the cipher-text Y produced by encryption of X using a key K can be represented by Y=E(K; X). Cipher-text Y is then transmitted to the client. For decrypting Y, a symmetric key decryption algorithm D may be used by the client. The plain-text X may be recovered by decrypting Y under key K according to D(K; Y)=X.

For the below description and call diagram 300, the following definitions are provided. “H” denotes concatenation of bit strings. REQ_R is a message requesting random data bit string R. TIME_C is a time stamp or other data time indicator of a message sent by a client C (such as client 104). TIME_S is a time stamp or other data time indicator of a message sent by server S (such as server 102 or 202). T stands for trusted authority (such as trusted authority 106 or 204). C represents a client, or, depending on context, a unique identifier bit string for the client (which may be public). S represents a server, or, depending on context, a unique identifier bit string for the server (which may also be public).

In step 302, the protocol is initiated with a request from a client C to a server S for random data bitstring R. C may choose which S to connect to by looking at a public lookup table. Block chain may be incorporated to ensure integrity of the public lookup table. It should be noted that the protocol can be initiated in a different manner to step 302. For example, S may send data to C informing C that R will be sent to it. Alternatively, C may send a request directly to trusted authority T, for example in a case where the client, server, and trusted authority are arranged as in system 200 of FIG. 2. In regard to call diagram 300 and FIG. 3, the trusted authority is described as if it is incorporated into the server (as in system 100 of FIG. 1), but may alternatively be external and abstracted from the server (as in system 200 of FIG. 2).

C and S may have pre-placed secret keys for their encryption and decryption. C and S may have access to a trusted time server to prevent replay attacks. Other methods of protecting against replays are possible, and include using time stamps, other time data, or using one or more counters. When C receives R it has the computational security of a strong encryption algorithm, such as AES. For practical purposes, R can be safely used to augment C's entropy pool. Moreover, C can provide further client-side encryption of R, as discussed above in relation to Approaches 2 and 3. In some embodiments, C can also decrypt R using a different key than was used to encrypt R by the server S. R can be combined into C's local entropy pool by, for example, hashing the concatenation of R with bits already present or generated at C. Thus, received entropy can be mixed with local entropy sources for further protection against corruption of the server and/or cracking of the protocol.

Back to call diagram 300, before, during, or after step 302, T generates two long-term master keys, K and L, which may be two sets of random numbers. T also generates a key encryption key K_{S}=H(K∥S) and a key authentication key L_{S}=H(L∥S) for S. T also generates a key encryption key K_{C}=H(K∥C) and a key authentication key L_{C}=H(L∥C) for C. T also calculates a non-secret (e.g., public) pair key P=H(K_{S}∥C)⊕H(K_{C}∥S), where the symbol ⊕ represents the XOR operation. T also calculates non-secret (e.g., public) authentication values Q_{SC}=H[L_{S}∥H(K_{C}∥S)] and Q_{CS}=H[L_{C}∥H(K_{S}∥C)].

In step 304, T provides K_{S} and L_{S} to S via a secure channel. In step 306, T provides K_{C} and L_{C} to C via a secure channel. The secure channels may be wireless channels, wired channels, or may alternatively be manual exchange where a USB or other memory device is connected to the server and/or client, and the encryption and/or authentication keys are provided.

In step 308, T provides P and Q_{SC} to S. In step 310, T provides P and Q_{CS} to C. Since P, Q_{SC}, and Q_{CS} are non-secret (e.g., public), these values may be communicated via non-secure (e.g., public) channels. For example, these values may be published in an online lookup table that remains available even if T were to go offline. S then calculates H (K_{S}∥C), which is S's key for receiving messages from C. C calculates H (K_{C}∥S), which is C's key for receiving messages from S.

Although steps 304, 306, 308, and 310 are depicted as being performed subsequent to step 302, in certain embodiments steps 304, 306, 308, and 310 may be performed before, during, or after step 302. For example, steps 304, 306, 308, and 310 may be performed during an enrollment phase before the client C requests random data bitstring R from server S.

In step 312, [REQ_R∥TIME_C∥H[H(K_{S}∥C)∥REQ0_R∥TIME_C] is transmitted from C to S. Here, C requests random data bitstring R from S with a time-stamped message authenticated with S's receive key, H(K_{S}∥C) which is for messages from C. To do this, C calculates H(K_{S}∥C) by XOR'ing H(K_{C}∥S) (which it had previously calculated after step 308 and 310) with P. C can also confirm the H(K_{S}∥C) value is correct by verifying that H(L_{C}∥H(K_{S}∥C))=Q_{CS}. On receipt of the message transmitted by C to Sin step 312, S verifies authenticity of request from C by checking the authentication tag using S's receive key H(K_{S}∥C) for messages from C. S can do this by independently calculating H[H(K_{S}∥C)∥REQ_R∥TIME_C], and confirming that this independently calculated value matches that transmitted from C to S. S can also confirm freshness of the time stamp TIME_C (e.g., that the time stamp is still valid), and if both check out proceeds to the next step. As discussed above, instead of using a time stamp, C and S can also mitigate the risk of replay attacks by using a counter.

In step 314, E[H(K_{C}∥S);R]∥TIME_S∥H[H(K_{C}∥S)∥E[H(K_{C}∥S);R]∥TIME_S] is sent from S to C. Here, S sends C a time-stamped message containing R that has been encrypted and authenticated under C's receive key, H(K_{C}∥S), which is for messages from S. To do this, S calculates H(K_{C}∥S), C's receive key for messages from S, by XOR'ing H(K_{S}∥C) with P. S can also confirm that the H(K_{S}∥C) value is correct by verifying that H[L_{S}∥H(K_{C}∥S)]=Q_{SC}. On receipt of the message transmitted by S to C in step 314, C verifies authenticity of message from S by checking the authentication tag using C's receive key, H(K_{C}∥S) for the message from S. C can do this by independently calculating H[H(K_{C}∥S)∥E[H(K_{C}∥S);R]∥TIME_S], and confirming that this independently calculated value matches that transmitted from S to C. C can also confirm the freshness from the time-stamp TIME_S. If authenticity and freshness are confirmed, C proceeds to the next step. As discussed above, instead of using a time stamp, C and S can also mitigate the risk of replay attacks by using a counter.

After step 314, C obtains R by decrypting with C's receive key for messages sent from S, using D{H(K_{C}∥S); E[H(K_{C}∥S);R]}=R. Alternatively, in using the mismatched keys implementation as described in approach 4, C may use its own, distinct key to decrypt the message received from S in step 314. C may thereafter combine R with random data from C's entropy pool to provide further transformation of the random data received from the server.

The process shown in call diagram 300 provides that R is hidden from adversaries such as eavesdroppers by a strong encryption algorithm. The client has assurance that R was produced by S and has not been modified by anyone other than the client and if client transformation or mis-matched decryption has been applied is unknown to anyone other than the client, including the server. The process shown in call diagram 300 can be extended to multiple clients. For example, T (whether incorporated in a server or as a standalone, external device) can provision multiple servers and multiple clients with necessary pre-placed secret keys and public keys, Ps and Qs, and can define which client can talk to which S. Clients also can be prevented from learning one another's client random bit string R. In some embodiments, however, a client may pass entropy to another client in the event of a server or client failure.

The process of diagram 300 also provides that coalitions of dishonest/compromised clients cannot compromise the communications between honest/uncompromised clients and the server. Moreover, forward security can be enforced by updating each party's key encryption key and key authentication key by applying hash H to it after each session, and updating P and the Q's accordingly. A future compromise of a receive key therefore cannot compromise past communications. Further, nonces can be used instead of time-stamps to protect against replay attacks by withdrawing some entropy from pre-supplied entropy or from C's local entropy pool.

As discussed above, diagram 300 represents an adaptation of Leighton and Micali's protocol, which was originally designed to facilitate transfer of secret, non-random, intelligent messages between parties, to the context of distributing random numbers from relatively small numbers of servers to relatively large populations of clients (for operational resilience and risk diversification). One of the common criticisms of Leighton and Micali's original protocol was that it required the publication of massive and unwieldy lookup tables for the public parameters Q_{SC} and Q_{CS}. For example, when facilitating transfer of messages between N parties, the protocol required publication of a table with N² entries, one for every pair of potentially communicating party. In the context of distributing random numbers between a number X of clients and a number Y of servers, however, the presently adapted and disclosed protocol requires only the publication of a table with a maximum size of XY entries. In certain embodiments, this table's size can be reduced still further. For example, when clients need only communicate with a limited number Z of servers, where Z<Y, then the lookup table need only have XZ entries. For example, in certain embodiments, clients can be configured to communicate with only two servers, such as to provide a primary and a backup supply of random data. In such cases, the lookup table need only have 2X entries. As a result, adapting Leighton and Micali's protocol for the purpose of distributing random data between servers and clients avoids one of the shortcomings of the original Leighton and Micali protocol while simultaneously achieving our goals of using lightweight and low CPU overhead symmetric algorithms that also have the expectation of being safe form quantum attack. Furthermore, the adaptation of this protocol to apply to a client-server model rather than client-client communication models removes the need share client data and keys between geographically dispersed server in real time.

1. A method for securely receiving encrypted random data at a client device from a server, the method comprising:
receiving, at the client device, an encrypted set of random data from the server, wherein the encrypted set of random data is derived by encrypting an original set of random data using a server key; and
transforming, at the client device, the encrypted set of random data by decrypting the encrypted set of random data using a client secret key that is unrelated to the server key to generate a third set of random data that is different from both the encrypted set of random data received by the client device and the original set of random data.

2. The method of claim 1, wherein:
the encrypted set of random data is derived by encrypting the original set of random data using the server key according to a symmetric key encryption-decryption algorithm; and
the encrypted set of random data is transformed at the client device by decrypting the encrypted set of random data according to the same symmetric key encryption-decryption algorithm, using the client secret key that is different from the server key.

3. The method of claim 2, wherein the symmetric key encryption-decryption algorithm is an Advanced Encryption Standard (AES) algorithm.

4. The method of claim 1, wherein:
the encrypted set of random data is derived by encrypting the original set of random data using the server key according to an asymmetric key encryption-decryption algorithm; and
the encrypted set of random data is transformed at the client device by decrypting the encrypted set of random data according to the same asymmetric key encryption-decryption algorithm, using the client secret key that is different from the server key, wherein the client secret key is not mathematically related to the server key according to requirements of the asymmetric key encryption-decryption algorithm.

5. The method of claim 1, wherein:
the encrypted set of random data is derived by encrypting the original set of random data using the server key according to a first encryption-decryption algorithm; and
the encrypted set of random data is transformed at the client device by decrypting the encrypted set of random data according to a second encryption-decryption algorithm.

6. The method of claim 1, further comprising refreshing the client secret key at random intervals.

7. The method of claim 1, further comprising refreshing, at the client device, the client secret key at intervals that are unknown to the server, wherein the server is not informed when the client secret key is refreshed.

8. The method of claim 1, further comprising:
receiving, at the client device, another set of random data from the server;
transforming, at the client device, the another set of random data using random data generated by a pseudorandom number generator local to the client device to derive a fourth set of random data;
updating, at the client device, the client secret key based on a first subset of the fourth set of random data;
determining, at the client device, a re-key interval based on a second subset of the fourth set of random data;
determining, at the client device, when the re-key interval has elapsed; and
when the re-key interval has elapsed, refreshing the client secret key.

9. The method of claim 1, further comprising:
receiving, at the client device, a secondary set of random data from a second server; and
transforming the third set of random data using the secondary set of random data to generate a combined set of random data.

10. The method of claim 1, further comprising using the third set of random data as a seed for a pseudorandom number generator local to the client device, or to calculate a key for encrypting data for transmission or storage.

11. A client device configured to securely receive encrypted random numbers from a server, the client device comprising:
at least one memory configured to store a client secret key;
a communication interface configured to receive data from the server; and
at least one processor coupled to the at least one memory and the communication interface, the at least one processor configured to:
receive, via the communication interface, an encrypted set of random data from the server, wherein the encrypted set of random data is derived by encrypting an original set of random data using a server key, and
transform the encrypted set of random data by decrypting the encrypted set of random data using a client secret key that is unrelated to the server key to generate a third set of random data that is different from both the encrypted set of random data received by the client device and the original set of random data.

12. The client device of claim 11, wherein:
the encrypted set of random data is derived by encrypting the original set of random data using the server key according to a symmetric key encryption-decryption algorithm; and
the encrypted set of random data is transformed at the client device by decrypting the encrypted set of random data according to the same symmetric key encryption-decryption algorithm, using the client secret key that is different from the server key.

13. The client device of claim 12, wherein the symmetric key encryption-decryption algorithm is an Advanced Encryption Standard (AES) algorithm.

14. The client device of claim 11, wherein:
the encrypted set of random data is derived by encrypting the original set of random data using the server key according to an asymmetric key encryption-decryption algorithm; and
the encrypted set of random data is transformed at the client device by decrypting the encrypted set of random data according to the same asymmetric key encryption-decryption algorithm, using the client secret key that is different from the server key, wherein the client secret key is not mathematically related to the server key according to requirements of the asymmetric key encryption-decryption algorithm.

15. The client device of claim 11, wherein:
the encrypted set of random data is derived by encrypting the original set of random data using the server key according to a first encryption-decryption algorithm; and
the encrypted set of random data is transformed at the client device by decrypting the encrypted set of random data according to a second encryption-decryption algorithm.

16. The client device of claim 11, wherein the at least one processor is further configured to refresh the client key at random intervals.

17. The client device of claim 11, wherein the at least one processor is further configured to refresh the client secret key at intervals that are unknown to the server, wherein the server is not informed when the client secret key is refreshed.

18. The client device of claim 11, wherein the at least one processor is further configured to:
receive, at the client device, another set of random data from the server;
transform, at the client device, the another set of random data using random data generated by a pseudorandom number generator local to the client device to derive a fourth set of random data;
update, at the client device, the client secret key based on a first subset of the fourth set of random data;
determine, at the client device, a re-key interval based on a second subset of the fourth set of random data;
determine, at the client device, when the re-key interval has elapsed; and
when the re-key interval has elapsed, refresh the client secret key.

19. The client device of claim 11, wherein the at least one processor is further configured to:
receive a secondary set of random data from a second server; and
transform the third set of random data using the secondary set of random data to generate a combined set of random data.

20. The client device of claim 11, wherein the at least one processor is further configured to use the third set of random data as a seed for a pseudorandom number generator local to the client device, or to calculate a key for encrypting data for transmission or storage.

21. A method for securely receiving random data at a client device from a server, the method comprising:
receiving, at the client device, a first set of random data from the server;
transforming, at the client device, the first set of random data using a client secret key to generate a second set of random data;
determining, at the client device, a random re-key interval;
determining, at the client device, when the re-key interval has elapsed; and
when the re-key interval has elapsed, refreshing the client secret key at the client device.

22. The method of claim 21, wherein the random re-key interval is unknown to the server, and the client secret key is refreshed at the client device without informing the server.

23. The method of claim 21, wherein determining the random re-key interval comprises:
transforming, at the client device, random data received from the server with other random data to generate a combined set of random data; and
determining the re-key interval based on a first subset of the combined set of random data.

24. The method of claim 23, wherein the other random data is generated by a pseudorandom number generator local to the client device.

25. The method of claim 21, wherein refreshing the client secret key comprises:
transforming, at the client device, random data received from the server with other random data to generate a combined set of random data; and
refreshing the client secret key based on a second subset of the combined set of random data.

26. The method of claim 25, wherein the other random data is generated by a pseudorandom number generator local to the client device.

27. The method of claim 21, wherein the first set of random data is encrypted by the server, the method further comprising decrypting, at the client device, the first set of random data before transforming the first set of random data using the client secret key to generate the second set of random data.

28. The method of claim 27, wherein the first set of random numbers is encrypted and decrypted using keys established according to a Leighton-Micali protocol.

29. The method of claim 21, wherein data received by the client from the server is authenticated and verified according to a Leighton-Micali protocol.

30. The method of claim 21, further comprising using the second set of random data as a seed for a pseudorandom number generator local to the client device, or to calculate a key for encrypting data for transmission or storage.

31. A client device configured to securely receive random data from a server, the client device comprising:
at least one memory configured to store a client secret key;
a communication interface configured to receive random data from the server; and
at least one processor coupled to the at least one memory and the communication interface, the at least one processor configured to:
receive, via the communication interface, a first set of random data from the server;
transform the first set of random data using a client secret key to generate a second set of random data;
determine a random re-key interval;
determine when the re-key interval has elapsed; and
when the re-key interval has elapsed, refresh the client secret key.

32. The client device of claim 31, wherein the random re-key interval is unknown to the server, and the at least one processor is configured to refresh the client secret key without informing the server.

33. The client device of claim 31, wherein the at least one processor is configured to determine the random re-key interval by being configured to:
transform random data received from the server with other random data to generate a combined set of random data; and
determine the re-key interval based on a first subset of the combined set of random data.

34. The client device of claim 33, wherein the other random data is generated by a pseudorandom number generator local to the client device.

35. The client device of claim 31, wherein the at least one processor is configured to refresh the client secret key by being configured to:
transform random data received from the server with other random data to generate a combined set of random data; and
refresh the client secret key based on a second subset of the combined set of random data.

36. The client device of claim 35, wherein the other random data is generated by a pseudorandom number generator local to the client device.

37. The client device of claim 31, wherein the first set of random data is encrypted by the server, and wherein the at least one processor is further configured to decrypt the first set of random data before transforming the first set of random data using the client secret key to generate the second set of random data.

38. The client device of claim 37, wherein the first set of random numbers is encrypted and decrypted using keys established according to a Leighton-Micali protocol.

39. The client device of claim 31, wherein data received by the client from the server is authenticated and verified according to a Leighton-Micali protocol.

40. The client device of claim 31, wherein the at least one processor is configured to use the second set of random data as a seed for a pseudorandom number generator local to the client device, or to calculate a key for encrypting data for transmission or storage.
